(19) United States
(12) Patent Application Publication
(10) Pub. No.: US 2010/0064245 A1
(43) Pub. Date: Mar. 11, 2010

(54) SYSTEM AND METHOD FOR PARALLEL DATA DISPLAY OF MULTIPLE EXECUTING ENVIRONMENTS

(75) Inventors: Jason M. Smith, Bellevue, WA (US); D. David Nason, Bainbridge Island, WA (US)

Correspondence Address: DAVIS WRIGHT TREMAINE, LLP/Seattle, 1201 Third Avenue, Suite 2200, SEATTLE, WA, 98101-3045, US

(73) Assignee: xSides Corporation, Bellevue, WA (US)

(21) Appl. No.: 12/554,706

(22) Filed: Sep. 4, 2009

Related U.S. Application Data
(63) Continuation of application No. 10/864,726, filed on Jun. 9, 2004, now abandoned.
Application No. 10/864,726 is a continuation-in-part of application No. 09/724,978, filed on Nov. 28, 2000, now Pat. No. 6,892,359.
Application No. 09/724,978 is a continuation-in-part of application No. 09/666,032, filed on Sep. 20, 2000, now Pat. No. 6,630,943.
(60) Provisional application No. 60/248,438, filed on Nov. 13, 2000.
(60) Provisional application No. 60/183,453, filed on Feb. 18, 2000.

(51) Int. Cl. G06F 3/048

(52) U.S. Cl. 715/778

(57) ABSTRACT

A computer display controller arbitrates between multiple environments in a computer system to apportion display space between the multiple environments. The display controller may be implemented in hardware, firmware, or software, and determines display space allocation based on requests or requirements of each of the environments. If only one environment is active, the display controller may allocate the entire display space to the first environment. When a second environment is activated, display parameters may be dynamically provided to the display controller or previously provided to the display controller for storage and subsequent use. The display controller apportions the total displayable area to accommodate both environments and if necessary alters the display parameters of the first environment to accommodate the display needs of the second environment. The process may be extended to additional environments and may operate satisfactorily with computer systems having multiple displays. The display controller may allocate the entire display space to a particular environment, or only a portion of the display space for a particular environment on a single or multiple display device system.

### BACKGROUND OF THE INVENTION

1. Field of the Invention

The present invention is directed generally to the control of a computer display and, more particularly, to a system and method for controlling a computer display between multiple environments.

2. Description of the Related Art

Computer security is an ever increasing area of concern for computer users. Frequent reports of computer viruses and operating system flaws point to weaknesses in security that can be exploited by unscrupulous individuals. While virus protection software and computer firewalls provide protection in a network environment, the display of confidential information on a computer system remains as a potential weakness in computer security. Accordingly, it can be appreciated that there is a significant need for techniques that protect the display of data on a computer and permit the display of data from multiple environments within the computer. The present invention provides this, and other advantages, as will be apparent from the following detailed description and accompanying figures.

### BRIEF SUMMARY OF THE INVENTION

The present invention is embodied in a system and method that permits a computer display to share display space between multiple environments. In an exemplary embodiment, a system operates in a processor using a memory to display data from multiple environments on a display device having a total display area. The system comprises a first environment comprising computer instructions stored in the memory and executed by the processor, with the first environment having data for display on the display device. The system also comprises a second environment comprising computer instructions stored in the memory and executed by the processor, the second environment having data for display on the display device, and a display controller to communicate with both the first and second environments to permit sharing of the total display area to thereby display first environment display data and second environment display data on the display device.

In one embodiment, the first environment is an operating system executed by the processor. The second environment may be a kernel executed by the processor in addition to the operating system. Alternatively, the second environment may be a second operating system executed by the processor in addition to the first operating system.

In exemplary embodiment, the display controller reduces a portion of the display area used by the first environment to display the second environment display data on the display device. The display controller may use a first predetermined portion of the total display area to display the first environment display data and a second predetermined portion of the total display area to display the second environment display data on the display device. In one embodiment, the first and second predetermined portions equals the total display area of the display device.

Alternatively, the display controller may use a first predetermined area of display of the first environment display data in a second predetermined area of display of the second environment on the display device.

The system may further comprise an input device operable by a user to toggle the focus between the first environment and the second environment. The display controller is responsive to the input device to thereby toggle the display device to display first environment display data when the focus is toggled to the first environment and to display second environment display data when the focus is toggled to the second environment.

### BRIEF DESCRIPTION OF THE DRAWING(S)

FIG. 1A is a functional block diagram of a computer system configured for operation in accordance with the present description using a hardware implementation.

FIG. 1B is a functional block diagram of a computer system configured for operation in accordance with the present description using a software implementation.

FIG. 2 is a functional block diagram illustrating the operation of the display controller of FIG. 1 as an arbitrator to arbitrate multiple environments.

FIG. 3 is a functional block diagram illustrating the operation of the display controller of FIG. 1 to control multiple environments for the display of data on multiple video display devices.

FIG. 4 is a flowchart of the operation of the system of FIG. 1 to execute and display multiple environments.

FIG. 5 is a flowchart illustrating the use of focus to determine apportionment of display space by the display controller of FIG. 1.

FIG. 6 is a flowchart illustrating the operation of the display controller of FIG. 1 to navigate between environments.

FIG. 7 illustrates the display of data from multiple environments on a computer display.

FIG. 8 is a flowchart illustrating the operation of the system of FIG. 1 using a pointing device to trigger viewing of the second environment.

FIG. 9 illustrates the use of a pointing device to toggle the display controller of FIG. 1 to display data for a second environment.

FIG. 10 illustrates the display of data in the second environment as triggered by the pointing device in FIG. 10.

FIG. 11 illustrates an alternative allocation of display space for multiple environments.

### DETAILED DESCRIPTION OF THE INVENTION

As will be discussed in greater detail herein, a display controller disclosed herein can be configured to operate in multiple environments and to arbitrate the allocation of display space on a display device between the multiple environments. The term environment, as used herein, refers to a microkernel, kernel, multiple kernels, applets, applications, operating systems or virtual machines. In a typical implementation, multiple environments are executing on a computer system and need display capability and a mechanism for arbitrating and apportioning the display between the multiple environments. The multiple environments may be any of the environments described above, such as multiple kernels, a first operating system main kernel, multiple operating systems, or the like. In addition, a computer system may include multiple display devices. In this event, it is necessary to arbitrate and apportion the display space in the multiple display devices to the multiple environments.

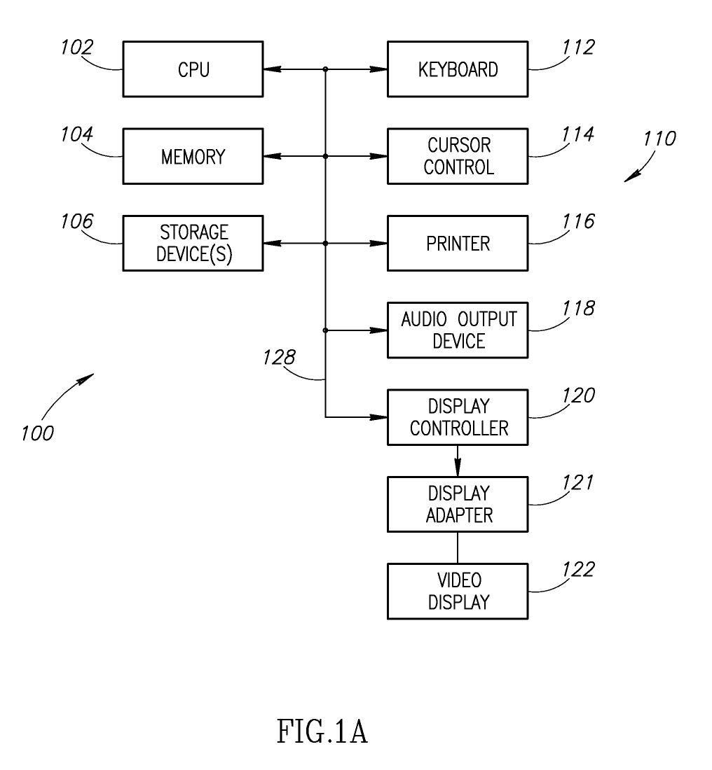

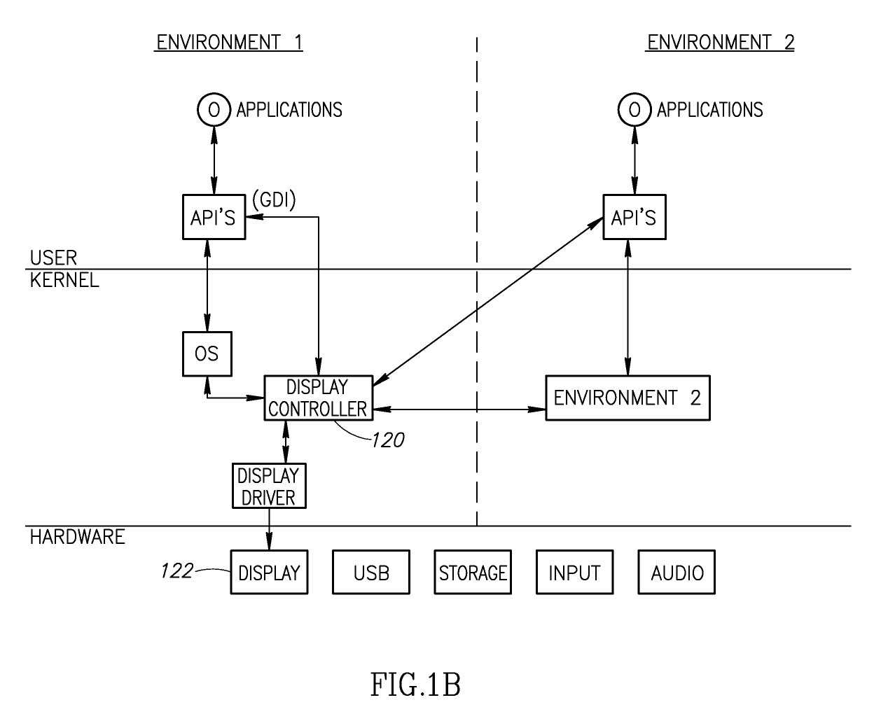

The techniques may be implemented in a system 100 illustrated in the functional block diagram of FIG. 1A. The system 100 includes a number of conventional components, such as a central processing unit (CPU) 102, a memory 104, and a storage device(s) 106. The CPU 102 operates on instructions and data provided by the memory 104 and by other devices, as is well known. The CPU 102 may be implemented by a variety of known components and may be a microprocessor, microcontroller, digital signal processor, programmable gate array, or the like. The present invention is not limited by the specific component used to implement the CPU 102. Similarly, the memory 104 may be implemented by a variety of well known components. The memory 104 may include read-only memory, random access memory, flash memory, and the like. In some embodiments, the CPU 102 may also include at least a portion of the memory 104. The system 100 is not limited by the specific component or components used to implement the memory 104.

The storage device(s) 106 may include one or more well known storage devices, such as a hard disk drive, optical storage drive (e.g., CD, CD±R, CD±R/W, DVD, DVD±R, and/or DVD±R/W, tape drive, RAM disk, or the like). The system 100 is not limited by the specific components used to implement storage device(s) 106.

The system 100 also includes a number of conventional input-output (I/O) devices 110. The I/O devices 110 may include, but are not limited to, a keyboard 112, cursor control device 114 (e.g., a mouse, trackball, joystick, or the like), a printer 116 and an audio output device 118. The operation of these I/O devices 110 is well known in the art and need not be described in greater detail herein.

Also illustrated in the functional block diagram of FIG. 1A is a display controller 120, which is coupled, via a display adapter 121, to a video display 122. The display adapter 121 is a conventional component that supplies the necessary synchronization signals and data to the video display 122. As will be described in greater detail below, the display controller 120 may act as an arbitrator to allocate space on the video display 122 to one or more environments. FIG. 1A illustrates a hardware implementation of the system 100. In this embodiment, the display controller may be part of the display adapter 121 or a separate hardware component. The display controller 120 may be implemented in hardware or firmware on the display adapter 121.

The various components described above are coupled together by a bus system 126, which may include an address bus, data bus, control bus, power bus, and the like. For the sake of clarity, those various busses are illustrated in FIG. 1A as the bus system 126.

The display controller 120 functions as more than a simple interface device to convert graphics data for delivery to the hardware display adapter 121. The display controller 120 functions as an arbitrator to identify data from multiple environments and to allocate display space to those multiple environments. The display controller 120 detects activation of a second environment and adjusts display parameters of the existing environment display to accommodate the second environment display data. If the second environment is deactivated, the display controller 120 can subsequently readjust the display parameters to accommodate only the first environment.

FIG. 1A is a functional block diagram illustrating a hardware implementation. Those skilled in the art will recognize that the inventive techniques described herein may be implemented in hardware, firmware, software, either alone or in combination. FIG. 1B is a functional block diagram of the system 100 illustrating a software implementation. Each environment has one or more applications being executed. In the example of FIG. 1B, the first environment has applications which, at a user level, include one or more application program interface (API). For video display, the API may include a graphics display interface (GDI).

In the embodiment of FIG. 1B, the display controller 120 is installed as a driver that operates in conjunction with the OEM display driver in order to support the display of multiple environments. The display controller operates at the kernel level and receives data directly from the GDI or from the API via one or more operating system calls. If a second environment were not present, the data from the GDI or APIs would normally go directly to the display driver. However, the display controller allocates the display between multiple environments. In the example of FIG. 1B, an application executing on the second environment also has one or more API. The API may communicate directly with the display controller 120 or communicate with the display controller via the second environment (e.g., a second operating system).

The display controller 120 determines the display requirements for the first and second environment and provides that information to the respective APIs to permit proper rendering into the allocated display space. Thus, each environment will properly render display data for its allocated display space. The rendered data is provided to the OEM display driver via the display controller 120. One advantage of the software implementation shown in FIG. 1B is that it does not require specialized hardware or specialized drivers that may otherwise be required for each display adapter 121. The display controller 120 refers to any implementation (e.g., hardware, software, firmware or combination) that arbitrates display space between multiple environments.

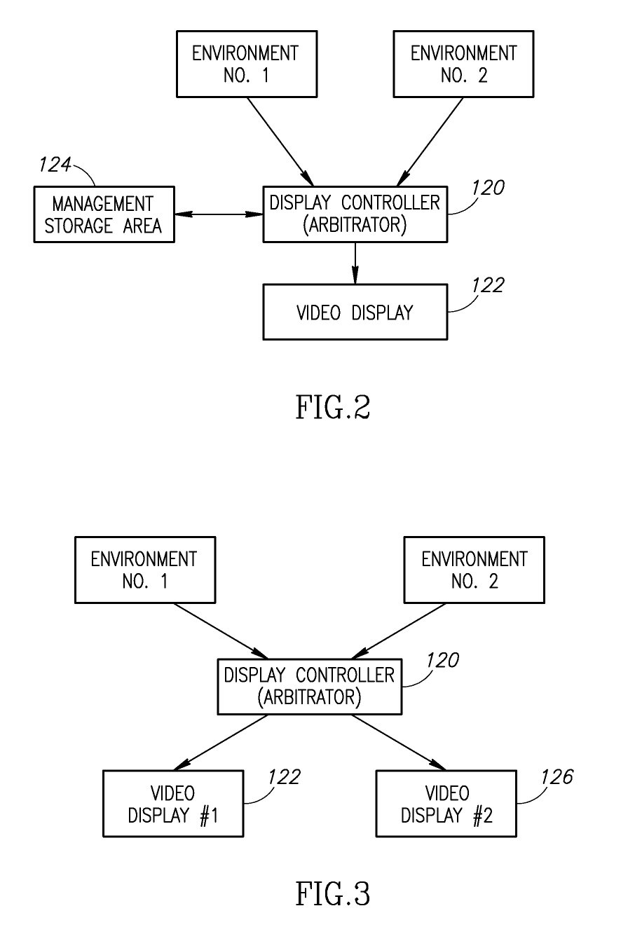

FIG. 2 is a functional block diagram illustrating the operation of the display controller 120 as an arbitrator for environment No. 1 and environment No. 2. Each of the environments may be considered a separate environment having its own requirements for video display area and/or video display resolution. In one embodiment, the environments may actually be executing on multiple processors. For example, environment No. 1 could be executing on a first processor and environment No. 2 could be executing on a second processor. Such multi-processor arrangements are known in the art. In this embodiment, the display controller 120 arbitrates between the multiple environments executing on the multiple processors.

In general, the environment or application in a particular environment that currently has focus is the environment or application that will receive the largest display area from the display controller 120 if a larger display area is required for proper rendering. The term “focus” is used herein to refer to systems with multiple environments wherein the active environment is deemed to have the focus. Input events (e.g., a keyboard event) are generally associated with the environment having focus. In certain operating systems, such as a Windows® operating system, the active window has focus.

Each environment or each application within an environment may have a needed or requested area for proper display. The display controller 120 may access a management storage area 124 with a list of applications in the environment and the ability for the display area to change, thus allowing the application the requested display area to properly render data. In other embodiments, the management storage area 124 may contain a list of predetermined display areas, a list of display locations or set of resolutions in a table for access by the display controller 120. In a software implementation of the display controller 120, the management storage area 124 may reside in the memory 104 (see FIG. 1). In a hardware implementation of the display controller 120, the management storage area 124 may be a memory storage device or area separate from the memory 104.

FIG. 3 illustrates the operation of the system 100 with multiple environments on multiple video displays. Some computer systems have a dual head controller, for operation with dual displays. As noted above with respect to FIG. 2, the multiple environments can be executing on a single processor or executing on multiple processors. Multi-processor computer systems are known in the art. In this embodiment, the display controller 120 arbitrates between the multiple environments executing on the multiple processors for multiple displays.

In the embodiment illustrated in FIG. 3, the video display 122 may function as a primary or first video display, while an additional video display 126 operates as a secondary video display. The display controller 120 can override and take control of part or all of the video display No. 1 122 or the video display No. 2 126. For example, environment No. 1 may be, by way of example, the primary operating system and is displaying data on both the video display No. 1 122 and video display No. 2 126. When environment No. 2 has display data, the display controller 120 will apportion the display to take part or all of either video display. In one example, the display controller 120 takes a portion of the video display No. 1 122 for display of second environment display data. Alternatively, the display controller 120 may take the entire video display No. 1 122 for display of second environment display data. In yet another alternative, the display controller 120 may take a portion of the video display No. 2 124. In yet another alternative embodiment, the display controller 120 may take all of the video display No. 2 126. In yet another alternative, the display controller 120 may take a portion of the video display No. 1 122 and a portion of the video display No. 2 126. In yet another alternative embodiment, the display controller may take all of the video display No. 1 122 and all of the video display No. 2 126 for the display of second environment display data.

In this embodiment, the display controller 120 functions as an arbitrator to detect activity associated with a particular environment and knows which display space to use. For example, the display controller 122 determines that environment No. 2 is active and directs output to the appropriate display space allocated for the second environment. The display controller 120 determines environment activity in a variety of manners. For example, the user may manually toggle back and forth between one environment and another. Alternatively, the display controller 120 determines which environment currently has the focus. For example, the user may have manipulated the cursor from the first environment to the second environment. The display controller 120 can readily determine, by virtue of the position of the cursor on the video display 122, which environment is active. In this manner, the display controller determines the appropriate allocation of display space on the video display 122.

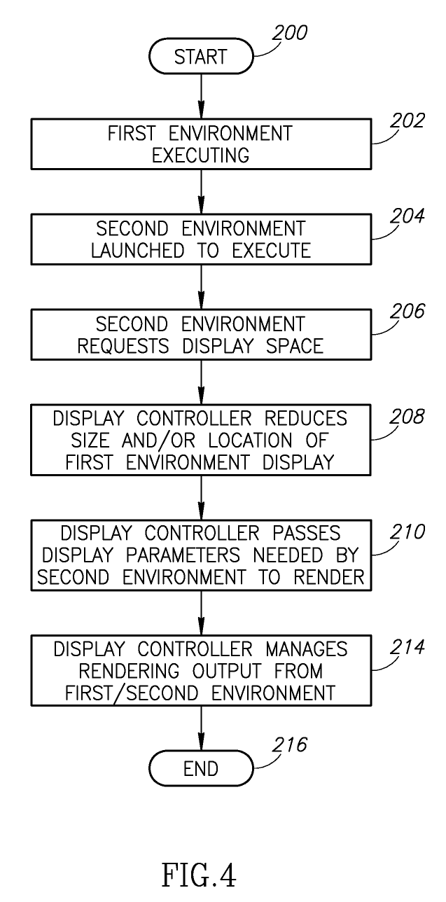

FIG. 4 is a high level flowchart illustrating the operation of the system 100. At a start 200, the computer system (see FIG. 1) is under power. At step 202, the primary operating system (OS) is executing as the first environment. At step 204, the second environment is launched to execute. As those skilled in the art will appreciate, the second environment may also have display data that requires the apportioning between the first and second environments by the display controller 120. The display requirements of the first and second environments may be conveniently stored within the management storage area 124 (see FIG. 2).

A registration process may be used to communicate the display requirements for the first and second environments to the display controller 120 for storage in the management storage area 124. The registration process will be described in greater detail below. In an exemplary embodiment, the second environment does not load or execute until a request is received to toggle to the second environment. The request may come from the user or from an application.

At step 206, the second environment requests display space. The user may manually request activation of the second environment. Alternatively, a number of different techniques for toggling between the first environment and the second environment are described herein. As described above, the display controller 120 may retrieve display parameters for the second environment from the management storage area 124. Alternatively, the system can accommodate a dynamic request for display space. In this embodiment, the dynamic request may include parameters for the amount of space required, display location and/or the display resolution required for effective display of data associated with the second environment. Other display parameters may include cursor type, size, shape, movement, display background color, texture, desktop size, and the like. Such display parameters are known in the art and can be readily altered when switching between environments.

At step 208, the display controller 122 reduces the size and possibly the location of the primary operating system display. In a multiple display system, such as that illustrated in FIG. 3, the reduction in size and/or location of the first environment display (i.e., the primary OS display) may involve the video display No. 1 122 and the video display No. 2 124.

A number of different known techniques may be used to alter the allocated display space. For example, U.S. Pat. No. 6,018,332, entitled “Overscan User Interface,” issued on Jan. 25, 2000, and assigned to the assignee of the present invention, describes the use of an overscan area for the display of data associated with a second environment. An alternative embodiment is described in U.S. Pat. No. 6,330,010, entitled “Secondary User Interface,” issued on Dec. 11, 2001, and assigned to the assignee of the present invention. That patent describes a technique by which operating system parameters are altered in a manner transparent to the operating system to alter display area and thereby create an additional space on a desktop for display of data associated with second environment. Another example is described in U.S. Pat. No. 6,661,435, entitled “Secondary User Interface,” issued on Dec. 9, 2003, and assigned to the assignee of the present invention. That patent describes a technique by which a video device driver operates without communicating via the operating system display interface to apportion the video display and thereby create an area of the video display that is capable of displaying output that is not obscured by output from the operating system display interface.

In step 210, the display controller 120 passes memory location, size and any other display parameters needed by the second environment to properly render second environment display data. Other examples of display parameters have been provided above. These parameters are returned to the portion of each environment which is responsible for rendering the data for the display. In one example, the portion of an environment responsible for rendering the display is a graphics device interface (GDI). In another example, a Windows® operating system has a redraw or “repaint” command that may be used in rendering a display. By passing these parameters back to the rendering portion of each environment, each environment is assured of rendering its own output data so that it will be properly rendered in the allocated display space.

In step 214, the display controller 120 manages the display parameters for rendered outputs so that both environment displays appear in parallel or in a complementary manner on the display device 122 or on the display devices 122 and 126 of FIG. 3 and the process ends at 216. In this manner, the display controller 120 arbitrates between the multiple environments to allocate display space according to the needs of each environment.

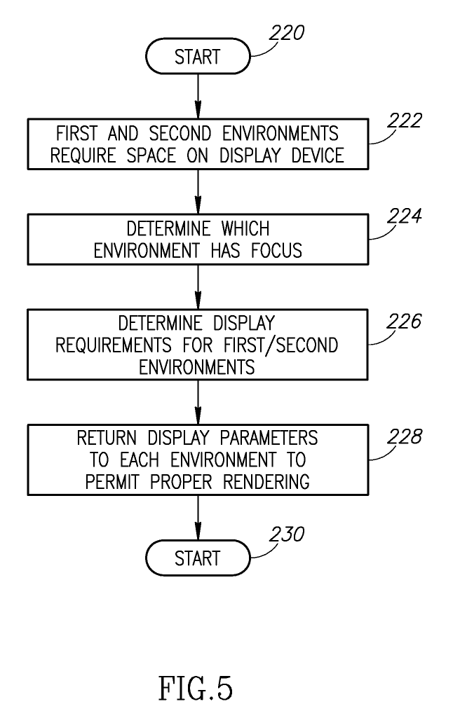

As previously discussed, a number of different techniques may be used to toggle between the multiple environments. FIG. 5 illustrates a flowchart of the operation of the system 100 in which focus is a determining factor in allocating a display space in a multiple environment system. At a start 220, it is assumed that environment 1 and environment 2 are both active. Those skilled in the art will appreciate that, upon startup, a computer may be configured such that the display controller 120 displays a single environment, or multiple environments. In step 222, both environment 1 and environment 2 need display space on the display device 122 (or the display devices 122 and 126 of FIG. 3).

At step 224, the display controller 120 determines which environment currently has focus. As is known to those skilled in the art, focus refers to the environment or portion of the display actively being used. For example, the display controller 120 can determine, on the basis of location of the cursor on the display device 122, which environment is active or has focus. In step 226, the display controller 120 determines the display requirements for the first and second environments. In a typical implementation, the environment having the focus will receive priority in the allocation of display space on the video display 122 (see FIGS. 1A-1B). In some embodiments, the environment with the focus may receive the larger display space for data display. However, the environment with the focus may not require a larger display space. Accordingly, the present invention is not limited by any specific allocation or apportionment of display space. As previously noted, the display controller 120 may allocate the entire display space on the display device 122 (or the display devices 122 and 126 of FIG. 3). Alternatively, the display controller 120 may allocate less than the entire display space of the display device 122 (or the display devices 122 and 126 of FIG. 3) to the environment currently having focus.

In step 228, the display controller 120 returns display parameters to each environment so they can properly render the associated display data and the process ends at 230. In this manner, the environment currently having the focus is given priority by virtue of the larger resolution or display space allocation. As previously discussed, the display space, locations and resolution requirements may be provided to the display controller 120 for storage in the management storage area 124 (see FIG. 2) or provided dynamically to the display controller each time the system 100 toggles from one environment to another. In this embodiment, the display space, location and if needed resolution requirements are passed to the display controller 120 each time a particular environment requests display space. Other display parameters, such as cursor size, shape, movement, display color, texture, and the like, may also be considered display parameters that may be passed dynamically to the display controller 120.

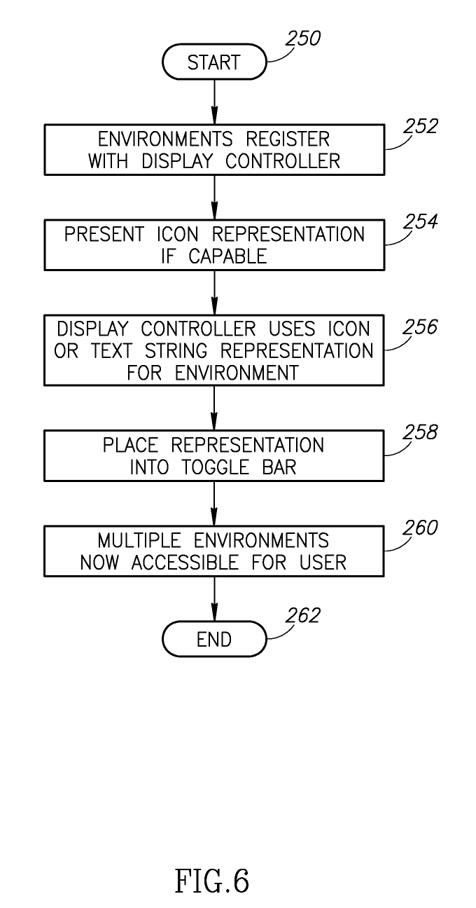

FIG. 6 illustrates the operation of a toggle bar or icons activated by a user to navigate between a first environment and a second environment. At a start 250, the computer system is operating. In step 252, an environment registers with the display controller 120. Data provided during the registration process may be provided to the display controller 120 for storage in the management storage area 124 for later recall and use. Alternatively, the system 100 can also accommodate dynamic registration. Dynamic registration refers to a process by which the registration data (e.g., display parameters) are provided to the display controller 120 at the time a particular environment is activated. For example, the user may manipulate the cursor to a particular location on the display device 122 indicating activation of a second environment. In response to the cursor manipulation, the second environment launches and provides the registration data to the display controller 120. In yet another alternative embodiment, an applet or application within the second environment may automatically launch upon activation of the second environment. The applet or application may set register data to automatically provide the desired display parameters and other registration data as needed. As part of the registration process, an application or environment name can be passed to the display controller 120 for storage in the management storage area 124 (see FIG. 2). For example, an environment name, such as env.1-Windows env.2-Secure Kernel, may be passed for storage in the management storage area 124. An environment registered in such a manner can contain a list indicating display requirements for proper operation of the environment. For example, the list may indicate the display area needed or locations on the video display 120 in which each registered environment will display its data.

In step 254, the environment may present the display controller with an icon representative of the environment. In step 256, the display controller 120 uses the icon provided in step 254 or simply a text string representative of the environment. In step 258, the display controller places the icon and/or text string into a toggle bar. In step 260, the multiple environments are now accessible for the user and the process ends at 262.

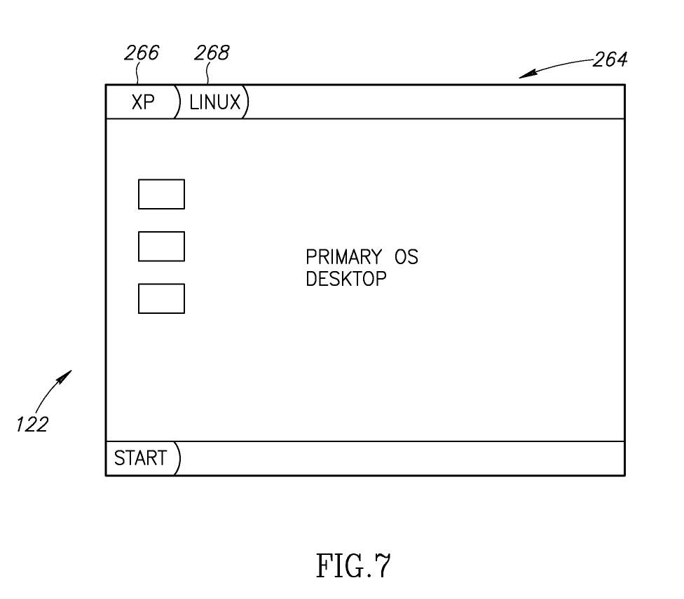

FIG. 7 illustrates the display 122 containing a toggle bar 264 to permit navigation between two environments. In the example of FIG. 7, the second display space is created in the form of the toggle bar 264 where the icons or text string presents the different environments that are available for selection by the user. An indicator 266 represents one environment while in indicator 268 represents a second environment. Additional environments (not shown) may also be illustrated on the toggle bar 264. In the particular example of FIG. 7, text strings are used in place of icon representations of the first and second environments, respectively. A remaining portion of the desktop in the display device 122 is allocated to the selected environment. In the example of FIG. 7, the remaining portion of the display device 122 is allocated to the primary OS desktop.

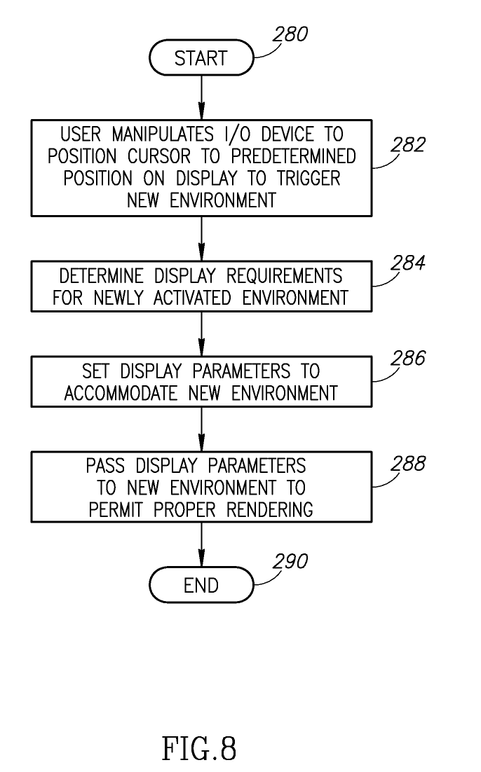

FIG. 8 is a flow chart illustrating the use of the cursor control device 114 (see FIGS. 1A-1B) to trigger viewing of a second environment. The use of user operable controls, such as the cursor control device 114, to alter the focus from a first environment to a second environment is described in U.S. Pat. No. 6,717,596 B1, entitled METHOD AND SYSTEM FOR CONTROLLING A COMPLEMENTARY USER INTERFACE ON A DISPLAY SURFACE, issued on Apr. 6, 2004 and assigned to the assignee of the present invention. In the present context, the user manipulates an I/O device 110 (see FIG. 1), such as a mouse, to position the cursor at a predetermined area of the desktop on the video device 122 to navigate between the first environment and the second environment. In an alternative embodiment, an I/O device 110, such as the keyboard 112 can be used to trigger activation of a particular environment. Use of arrow keys, function keys, or any predetermined key or combination of keys on the keyboard 112 may be used to activate an environment or to switch between environments.

With respect to FIG. 8, at a start 280 the first and second environments are both operating on a computer system (e.g., the system 100 of FIG. 1). In step 282, the user moves the cursor control device 114 over to an area of the display device 122 to trigger the second environment to be displayed.

In step 284, the display controller 120 (see FIG. 1) determines the amount of display space and/or other display parameters required by the second environment. In step 286, the display controller 122 sets the first environment display parameters to new parameters to accommodate the allocation of a portion of the display space for use with the second environment.

In step 288, the display controller 120 passes parameters to the second environment to permit proper rendering of the second environment display data and the process ends 290. In this manner, the display controller 120 alters the display parameters for the first environment to accommodate the addition of display space for use with the second environment.

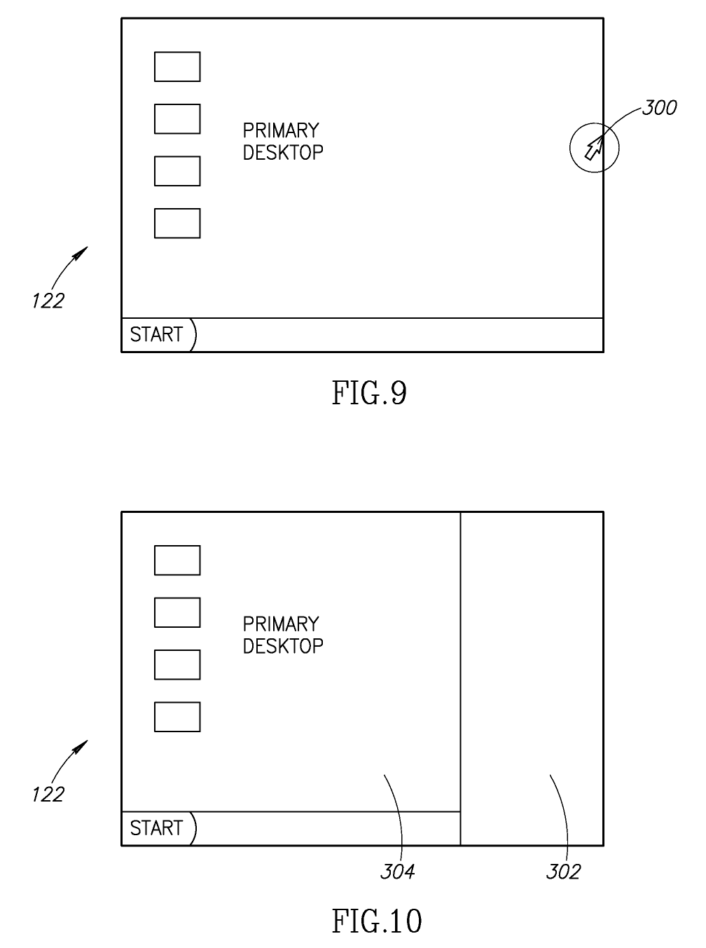

FIGS. 9 and 10 illustrate the use of the cursor control device to activate the display for the second environment. In FIG. 9, the display device 122 is completely allocated to the first environment and the display parameters are appropriately set to allow the first environment complete access to the total displayable space. The cursor control device 114 is manipulated to maneuver a cursor 300 to an edge of the display device 122. When the cursor 300 is positioned at the edge of the display device 122, the second environment now gains a portion 302 of the display space on the display device. Those skilled in the art will recognize that the second environment could take the entire display space if necessary. The display controller 120 passes the appropriate parameters to the second environment for proper display rendering into the portion 302 or the total display area, as appropriate.

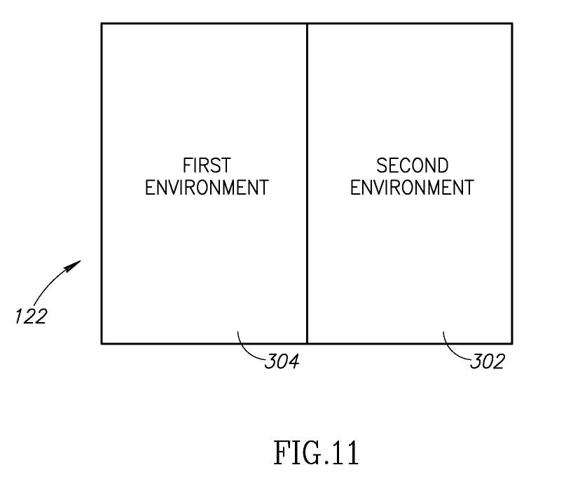

FIG. 11 illustrates a different apportionment between environment 1 and environment 2 on the display device 122. In FIG. 11, the display device 122 is approximately evenly split between the first and second environments, with environment 2 receiving a portion 302 of the total display space while environment 1 receives a portion 304 of the total display space. In one embodiment, the portions 302 and 304 equal the total displayable area of the display device 122.

FIGS. 9 and 10 illustrated the use of the cursor control device 114 to toggle between the first environment and the second environment. FIG. 7 illustrated the use of a toggle bar 264 to switch between the first environment and the second environment. Those skilled in the art will recognize that other variations may also be used. For example, activation of the keyboard 112 in a predetermined manner may be used to toggle between the first and second environments. Furthermore, the principles of the present invention may be extended beyond first and second environments. The display controller 120 may arbitrate space between virtually any number of environments. The only practical limitation is the physical size of the display and allocating an environment large enough to be seen by a user. However, large display sizes or multiple display devices, such as the display devices 122 and 126 of FIG. 3, can more readily accommodate multiple environments. Accordingly, the present invention is not limited by a particular number of environments under control of the display controller 120.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

We claim:

1. An apparatus operating on a processor using a memory for displaying data from multiple environments on a display device having a total display area, the apparatus comprising:
a first set of computer instructions stored in the memory and executed by the processor to thereby form a first environment, the first environment having data for display on the display device;
a second set of computer instructions stored in the memory and executed by the processor to thereby form a second environment, the second environment having data for display on the display device; and
a display controller configured to communicate with both the first and second environments to apportion the total display area to thereby displaying first environment display data and second environment display data on the display device.

2. The apparatus of claim 1 wherein the first environment is a first operating system executed by the processor.

3. The apparatus of claim 2 wherein the second environment is a kernel executed by the processor in addition to the first operating system.

4. The apparatus of claim 2 wherein the second environment is a second operating system executed by the processor in addition to the first operating system.

5. The apparatus of claim 1 wherein the display controller allocates a portion of the total display area used by the first environment to display the second environment display data on the display device.

6. The apparatus of claim 1 wherein the display controller allocates the total display area used by the first environment to display the second environment display data on the display device.

7. The apparatus of claim 1 wherein the display controller uses a first predetermined area of display of the first environment display data and a second predetermined area of display of the second environment display data on the display device.

8. The apparatus of claim 1 wherein the display controller uses a first predetermined portion of the total display area to display the first environment display data and a second predetermined portion of the total display area to display the second environment display data on the display device.

9. The apparatus of claim 8 wherein the first and second predetermined portions equals the total display area of the display device.

10. A computer-readable media comprising computer instructions for displaying data from multiple environments on a display device having a total display area, the computer-readable media comprising to cause a processor to:
execute computer instructions in a first environment, the first environment having data for display on the display device;
execute computer instructions in a second environment, the second environment having data for display on the display device; and
control the display device by communicating with both the first and second environments to apportion the total display area to thereby display first environment display data and second environment display data on the display device.

11. The computer-readable media of claim 10 wherein executing computer instructions in the first environment comprises executing instructions for a first operating system.

12. The computer-readable media of claim 10 wherein executing computer instructions in the second environment comprises executing instructions for a kernel.

13. The computer-readable media of claim 10 wherein executing computer instructions in the second environment comprises executing instructions for a second operating system in addition to the first operating system.

14. A method operating on a multi-processor computer system for displaying data from multiple environments on a display device having a total display area, the method comprising:
executing computer instructions in a first environment by a first processor, the first environment having data for display on the display device;
executing computer instructions in a second environment by a second processor, the second environment having data for display on the display device; and
controlling the display device by communicating with both the first and second environments to apportion the total display area to thereby display first environment display data and second environment display data on the display device.

15. The method of claim 14 wherein executing the computer instructions in the first environment comprises executing instructions for a selected one of a group comprising an application, an applet, a kernel, a microkernel, an operating system, and a virtual machine.

16. The method of claim 14 wherein executing the computer instructions in the second environment comprises executing instructions for a selected one of a group comprising an application, an applet, a kernel, a microkernel, an operating system, and a virtual machine.

17. The method of claim 14 wherein controlling the display device comprises allocating a portion of the total display area used by the first environment to display the second environment display data on the display device.

18. The method of claim 14 wherein controlling the display device comprises allocating the total display area used by the first environment to display the second environment display data on the display device.

19. The method of claim 14, further comprising controlling the display device to display first environment display data when a focus is changed to the first environment and to display second environment display data when the focus is changed to the second environment.

20. The method of claim 19, further comprising detecting user operation of an input device to toggle the focus between the first environment and the second environment, and in response to the input device, toggling the display device to display first environment display data when the focus is toggled to the first environment and to display second environment display data when the focus is toggled to the second environment.
